(19) United States
(12) Patent Application Publication
(10) Pub. No.: US 2010/0316987 A1
(43) Pub. Date: Dec. 16, 2010

(54) EDUCATIONAL SERVICES AND CONTRACTS

(75) Inventors: Ellery Charlson, Bothell, WA (US); Lei Wang, Redmond, WA (US); Mohamed Rouatbi, Bellevue, WA (US); Parul Ranjit Manek, Redmond, WA (US); Rajeev Kumar Mittal, Redmond, WA (US); Xin Li, Redmond, WA (US); Zhipeng Zhao, Bellevue, WA (US); Zubin Alexander, Bothell, WA (US); Kevin C. Gammill, Beaux Arts, WA (US); Qin Zhou, Kirkland, WA (US); Yonit Manna, Bellevue, WA (US); Brian James Hardy, Duvall, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/485,067

(22) Filed: Jun. 16, 2009

(51) Int. Cl. G09B 7/00; G06F 9/54

(52) U.S. Cl. 434/362; 719/313

(57) ABSTRACT

Described is a technology in which an educational service provides contracts (an interface set) for calling functions that allow management of educational-related data. The interface set may be divided as interfaces to various services; roles associated with users of the educational service determine which interfaces/functions each user can call. The interfaces may include interfaces for calling course-related functions (e.g., of a course service), profile-related functions (e.g., of a profile service), membership-related functions (e.g., of a membership service) and task-related functions (e.g., of a task service). Other interfaces may include interfaces for calling plan-related functions, group-related functions, content-related functions, notification-related functions, provisioning-related functions, institution-related functions, department-related functions, utilities-related functions, standards-related functions, degree program-related functions, contextual communication-related functions and/or scoring related functions.

### CROSS-REFERENCE TO RELATED APPLICATION

The present application is related to copending U.S. patent application Ser. No. ______ (attorney docket no. 326645.01) entitled “Educational Entity Architecture and Object Model,” filed concurrently herewith, assigned to the assignee of the present application, and hereby incorporated by reference.

### BACKGROUND

Education is an area in which various entities, such as courses, tasks, institution, school, department, degree programs and so forth have many relationships between them. While some of these entities are the same or similar among virtually all educational institutions, institutions also have a number of needs that are somewhat tailored to their individual circumstances. For example, an elementary school and a university have different needs.

Heretofore, there was no consistent and organized way for institutions to access such entity-related data and their relationships. What is needed is such a way, while at the same time being flexible and extensible for the varied circumstances of educational institutions.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which an educational service provides contracts (an interface set) for calling functions that allow management of educational-related data. The interface set may be divided as interfaces to various services. In general, one or more roles associated with users of the educational service determine which interfaces/functions each user can call. For example, a teacher can call task-related functions to associate tasks with a course instance, whereby the students associated with that course can see their tasks.

In one aspect, the interfaces may include interfaces for calling course-related functions, profile-related functions, membership-related functions, and/or task-related functions of the educational service. For example, a course interface provides for calling functions of a course service, a profile interface provides for calling functions of a profile service, a membership interface provides for calling functions of a membership service, and or a task interface provides for calling functions of a task service.

Other interfaces that may be present in the educational service include interfaces for calling plan-related functions, group-related functions, content-related functions and/or notification-related functions. Still other interfaces may be provided for calling provisioning-related functions, institution-related functions, department-related functions, utilities-related functions, standards-related functions, degree program-related functions and/or contextual communication-related functions.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIGS. 1A and 1B comprise a block diagram showing example contracts (interfaces) to various services of an educational service.

FIG. 2 is a representation of a middle tier component of the educational service that executes the various services' functions as called via their corresponding interfaces.

FIGS. 3A-3C comprise a representation of how educational service data and functionality may be provided to students and teachers in an example scenario.

FIGS. 4A and 4B comprise a representation of task concepts for creating, maintaining and working with tasks in an educational service.

FIGS. 5A and 5B comprise a representation of how educational service data and functionality may be provided to various users in an example scenario.

FIG. 6 shows an illustrative example of a computing environment into which various aspects of the present invention may be incorporated.

### DETAILED DESCRIPTION

Various aspects of the technology described herein are generally directed towards an educational service and service contracts (e.g., including defined interfaces) which provide a way to create and consume educational data for institutions and other educator/learner scenarios in a seamless manner. To this end, there is provided an educational service architecture model by which users consume and extend on data, via an extendable middle tier and extendable provider model. As will be understood, the educational services are extendable at the service level by the additional of new services or by adding new functionality to existing services. Further, the educational services are extendable at the middle tier level, in which a client user can extend existing educational services by building an additional service or application layer on top of the educational services.

It should be understood that only a relatively small number of examples are described herein, and thus any of the examples described herein are non-limiting examples. Moreover, other fields such as healthcare, finance and so forth may benefit from the technology described herein. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and data access in general.

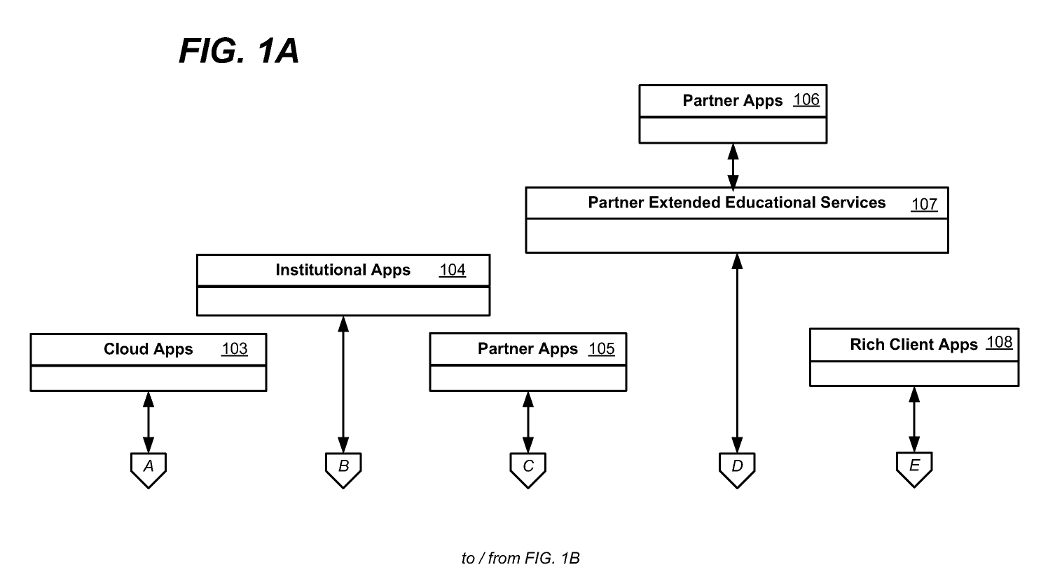

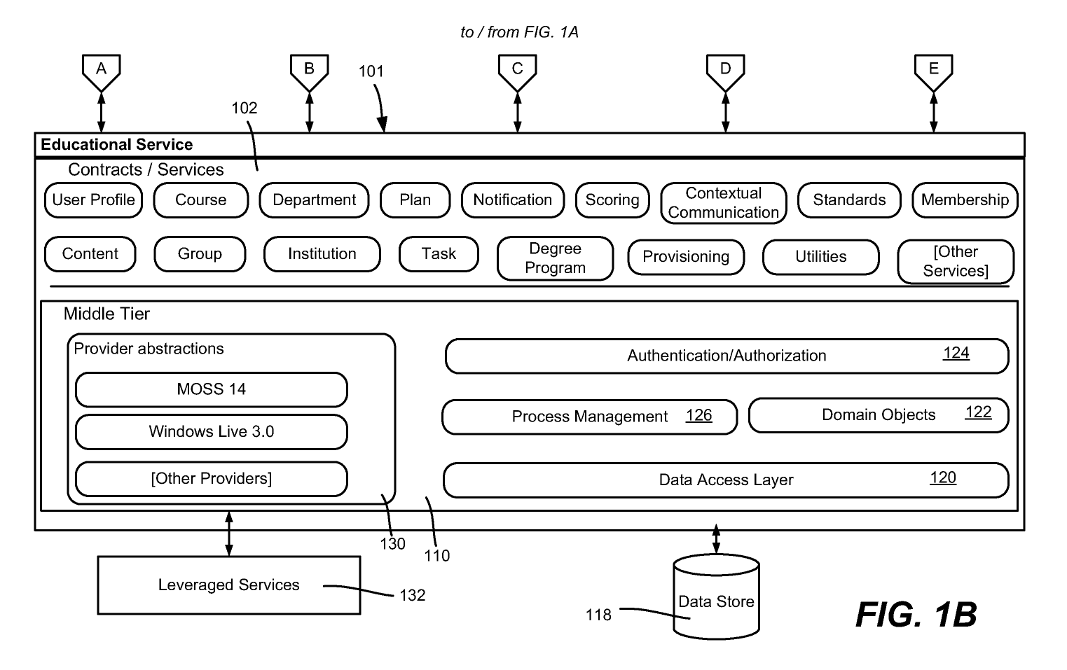

Taken together, FIGS. 1A and 1B show one implementation of an educational entity architecture model, in which an educational service 101 (FIG. 1B) provides various services via contracts thereto (contracts/services 102) for access by various service-related, institutional, user (e.g., partner or client) and or other applications and/or other services 103-108 (FIG. 1A). As described below, the access to the contracts/services 102 is performed by modules and the like in a middle tier 110. The service 101 may be implemented via a web service and/or a SharePoint® shared service, for example.

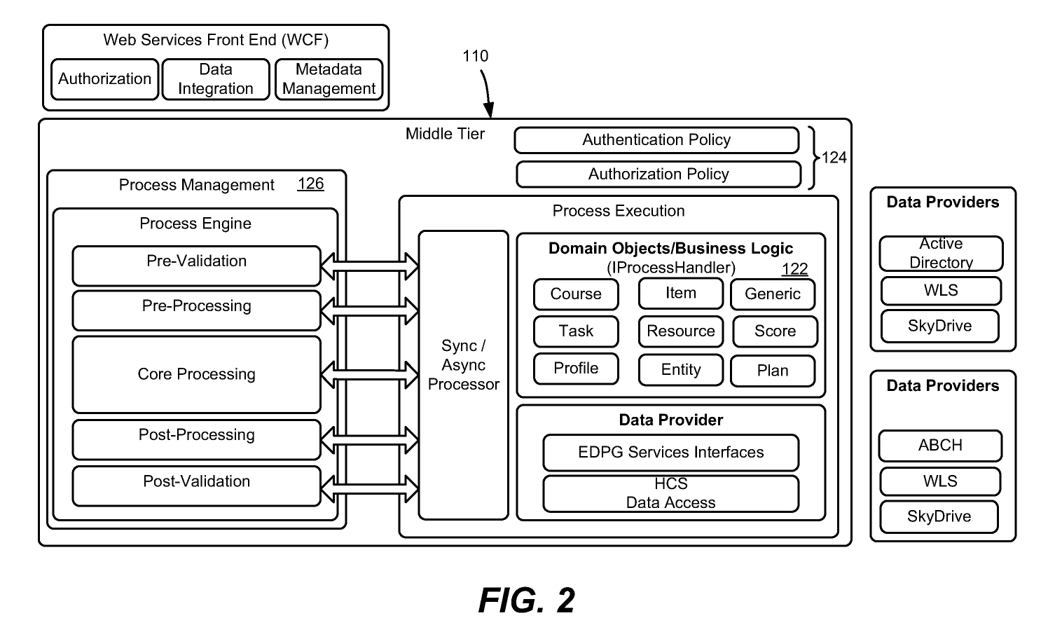

The middle tier 110, shown in additional detail in FIG. 2, provides access to the data based upon which of the contracts/services 102 is called. To access educational data for example, such as the data described in the aforementioned “Educational Entity Architecture and Object Model” related patent application, the middle tier 110 interfaces with a suitable data store 118 via a data access layer 120 to instantiate domain objects 122. The middle tier 110 includes an authentication/authorization module including policy 124, along with process management module 126, to control access to reading and writing such data.

Further, the middle tier 110 includes provider abstractions 130 for accessing leveraged services 132. Examples of leveraged services 132 include Windows Live®, Microsoft Office and so forth.

As mentioned above, the services of the educational service 101 are exposed through service contracts, which partners may use to build applications or extended services on top of the educational service 102. Note that services provided include (but are not limited to) Profile, Course, Task, Plan, Scoring, Group, Content, Contextual Communication, Notification, Provisioning, Institution, Department, Utilities, Membership, Standards and Degree Program. In one implementation, the services are grouped functionally so that partner and client can consume appropriate services. Additional details of some of the example interfaces are set forth below.

The course service is accessed through a course interface, which provides a set of APIs (application programming interfaces to functions) for creating and manipulating courses. These APIs are those relevant to some active course that is being taught, e.g., to create a course, to create an instance of a course (e.g., Economics 301 may be taught at different times, and/or with different teachers, and each is a different instance), and so on. A course may be tied to course materials, and associated with tasks, such as assignments. Various users may be added to a course, e.g., with different types of members (e.g., student, teacher, teacher's assistant, and so forth) with different roles corresponding to different course privileges from the course perspective. For example, a teacher may create and modify an assignment (task) for the course instance including scoring, but the student may not modify or delete that task; however the student can do submissions against assignments

The task service is accessed through a task interface, which provides APIs typically (but not necessarily) directed towards creating and manipulating assignments. Assignments are created as tasks by a teacher, and task instances are created for students to work on so that student activity on a task is distinct and can be tracked. This service also provides the ability to associate a task with courses, groups, institutions, a plan, a profile, a department and a degree program.

However, other types of tasks are present throughout the system that are not necessarily related to a course. For example, administrative tasks related to an institution, school department, degree program may be created and manipulated by users with the appropriate role. Any user at any level may create and manipulate personal tasks. A task may be tied to materials.

The group service is accessed through a group interface, which provides a set of APIs for creating and manipulating general groups. Groups are generally logical and potentially overlapping collections of users (for example, the participants in several course instances), and also may be used to define roles, such as instructor and student. Using group providers allows setting permissions to perform group-related actions such as adding and removing members from a group, and tying these permissions to roles defined and maintained by the group provider. For example, a study group or a hobby group may be created and accessed through this interface. Materials may be tied to a group, e.g., one study group may be assigned to one project, and another study group to another project. In one implementation, the interface allows creating/deleting groups, retrieving group properties, and retrieve groups associated with specific entities.

The profile service is accessed through a profile interface, and provides services for creating and managing personal information. A profile maintains a definition of a user in the system and the operations available to that user. A user can have multiple roles at any time for different domain objects, and can have tasks, and items associated with that user which can be accessed via the task and content service. Example profile information includes user names and passwords tied to user management providers, roles and so forth. Other examples may be the courses being taken by a student user, associated EPortfolios, the degree being sought, and so forth.

The plan service is accessed through a plan interface. The plan service provides services for creating and managing plans including course, personal, career and so forth.

The scoring is accessed through a score interface. The Score service provides services for managing scores related to any submissions tied to a task instance (assignment).

The notification service is accessed through a notification interface, and provides services for creating and managing notifications. In general, the notification service provides a simple interface to retrieve commonly desired notifications, such as past due assignments, and send emails, text messages, and so forth. Further, the notifications interface allows for clients to plug into a notifications engine and create custom notifications. The notification service also allows complex queries to be performed on the middle tier, which saves application developers the overhead associated with making multiple requests to web services and processing the data within the application or client. Notifications are typically not persisted in the data store.

The contextual communication service is accessed through a contextual communication interface, and provides services for creating and managing contextual communication. Example contextual communications are typically tied to a course or assignment, and for example may directed towards providing feedback, typically from a teacher to a student, such as regarding a submitted assignment.

The provisioning service is accessed through a provisioning interface, and provides services for provisioning. Provisioning is generally directed towards setting up an institution, e.g., migrating data, setting up email accounts, setting up host services, and so forth.

The content service is accessed through a content interface, and provides services for creating and managing educational related content. These can be associated with Tasks, Courses, groups, institutions, plan, profile, department and degree program, for example.

The department service is accessed through a department interface, which provides a set of APIs for creating and managing departments. This includes department administration functionality such as creating courses, adding members to the department, adding degree programs, and so forth.

The degree program service is accessed through a degree program interface, which provides a set of APIs for creating and managing degree programs. In other words, the degree program service creates degree program instances for students, which keep associations with department, courses and so forth. Examples data maintained in a degree program service include prerequisites, course requirements and so forth. A degree program may be tied to one or more departments.

The institution service is accessed through an Institution interface, which provides a set of APIs for creating and managing institutions, typically by an IT administrator. For example, this includes institution administration functionality such as creating departments, creating courses, adding degree programs, and so forth.

The standards interface/service is directed towards coupling the service to another standard, e.g., data maintained in another format. The utility interface/service is directed towards maintaining extended properties that may be associated with a given object. The membership interface/service is for membership management, e.g., managing the roles associated with each user, e.g., remove a department level user, add a student to a course, and so forth.

Although the interfaces and services are logically separated in one implementation, it is understood that other alternatives are feasible. For example, the functions of two or more services can be accessed through a common interface, and/or the functions of two services may be merged into a single service with more functions. As a more particular example, a hypothetical “Administration” interface may be used for calling both the “Department” and “Institution” functions. Thus, as used herein, “interface” generally refers to a way for any logic including program code to call defined functions of a “service.”

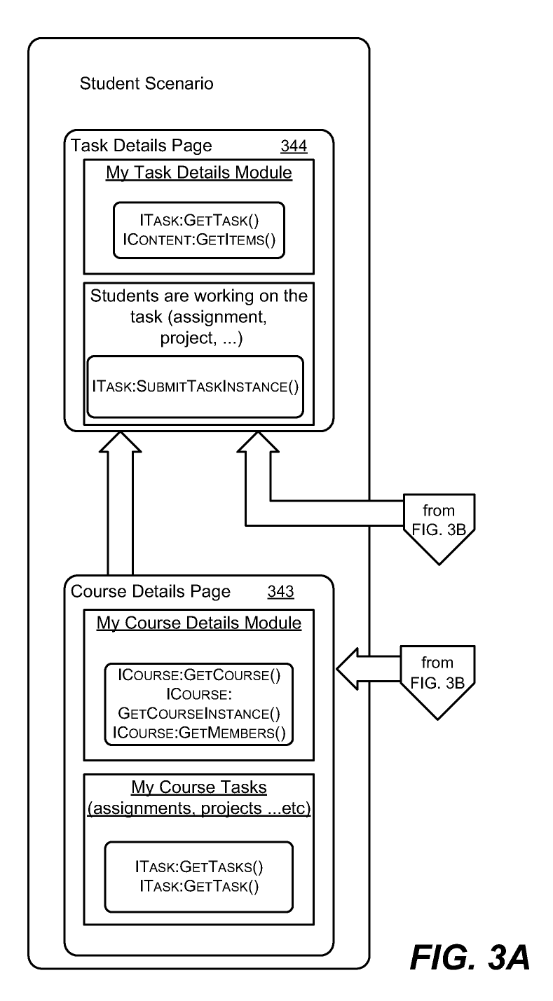

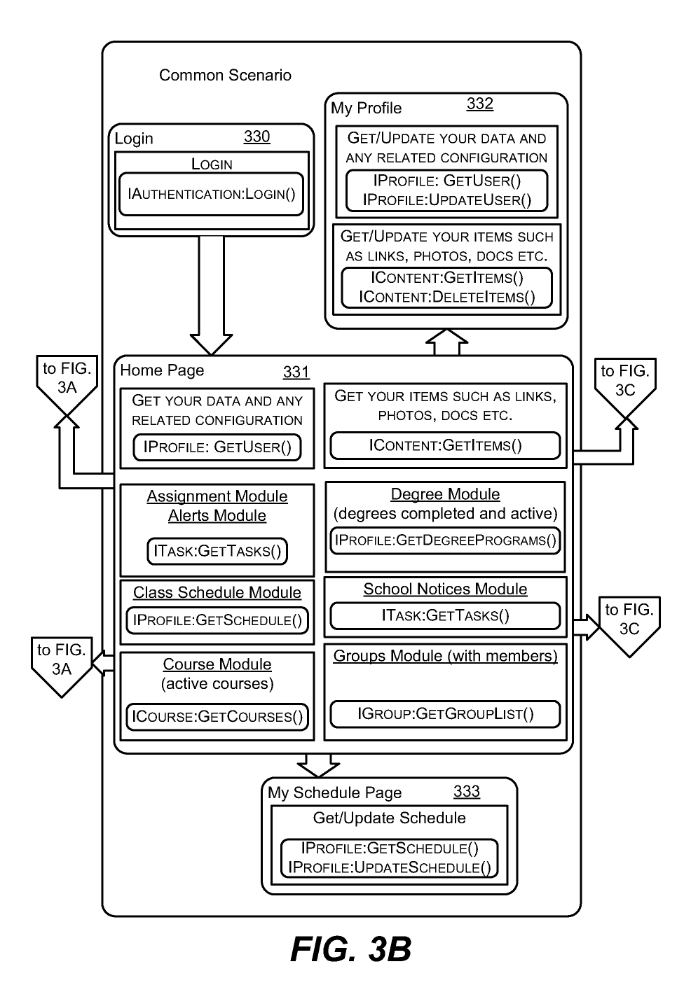

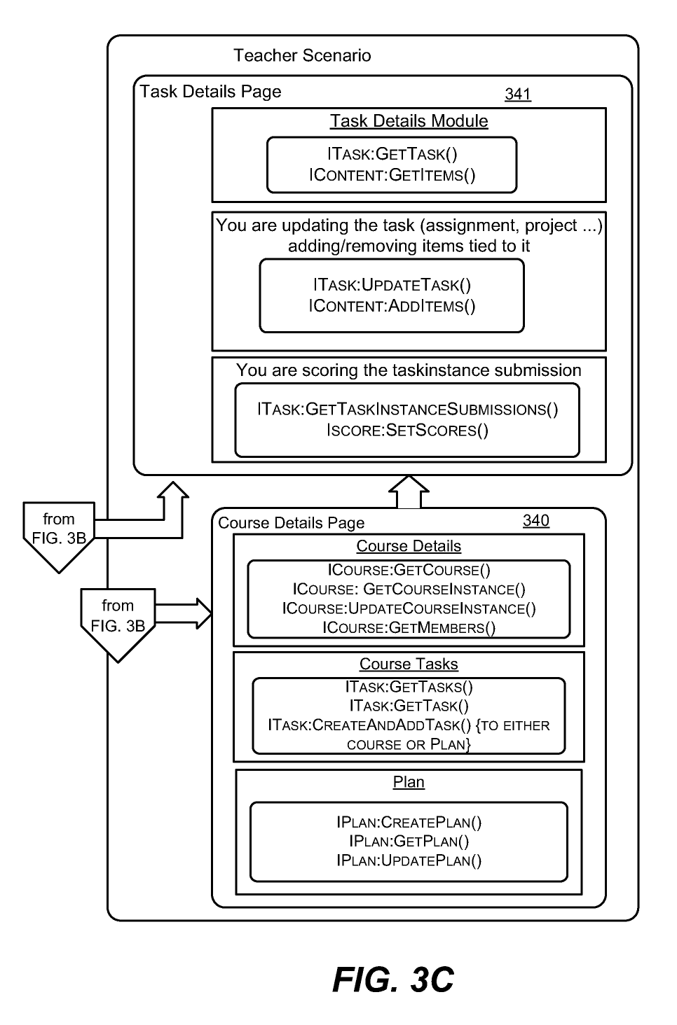

By way of an example of how these interfaces are used, FIGS. 3A-3C show data flow from a student (FIG. 3A) and teacher (FIG. 3C) perspective, with FIG. 3B representing actions common to both students and teachers. For example, both students and teachers login (block 330) to a home page 331, can see their profile data 332, and link to a schedule page 333.

As shown in FIG. 3C, for a given course (e.g., set up by an administrator), a teacher may interact with course details and assign tasks via the corresponding contracts. A course details page 340 and task details page 341 are provided for these actions, respectively.

Students also see a course details page 343 and task details page 344. However the student, who has a different role, does not have the same interfaces as the teacher. For example, the student may submit task instance submissions, but cannot add tasks, cannot update the course instance, cannot create a course plan, and so forth.

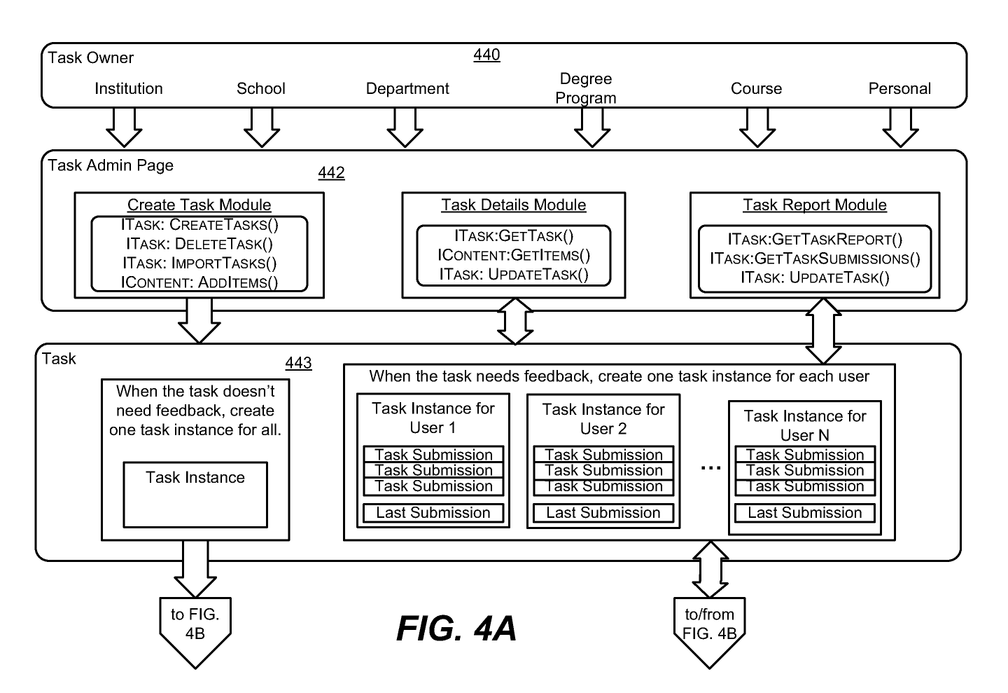

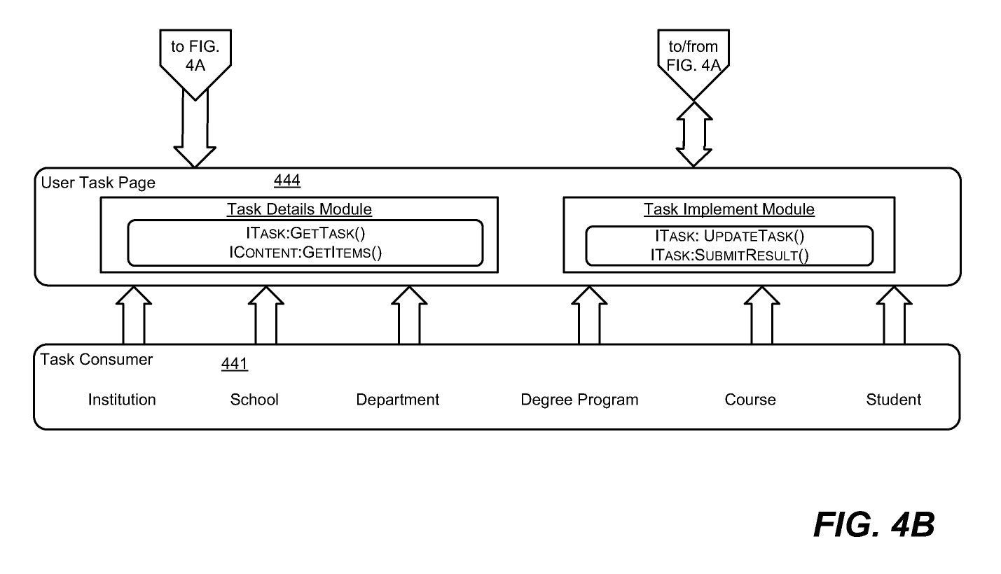

FIGS. 4A and 4B taken together provide example data flow and scenarios regarding tasks, as well as example modules having interfaces to functions therein. As can be seen, there is a task owner 440 (FIG. 4A) and a task consumer 441 (FIG. 4B). A task administration page 442 is used to create a task 443. From the consumer's perspective, the task 443 is accessed from a user task page 444. Note that the use only sees user-assigned tasks, not the tasks assigned to other users. As can be seen in FIG. 3C, a teacher can also work with tasks that are related to scoring. That is, the teacher can score an instance submission via an interface accessed through the task details page 341.

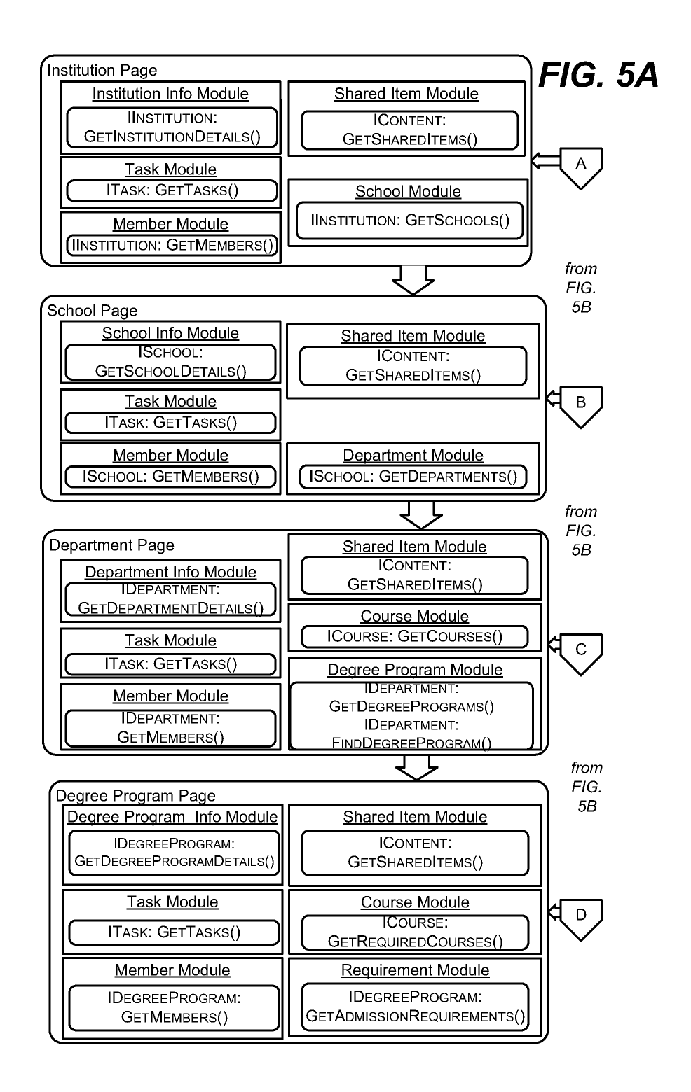

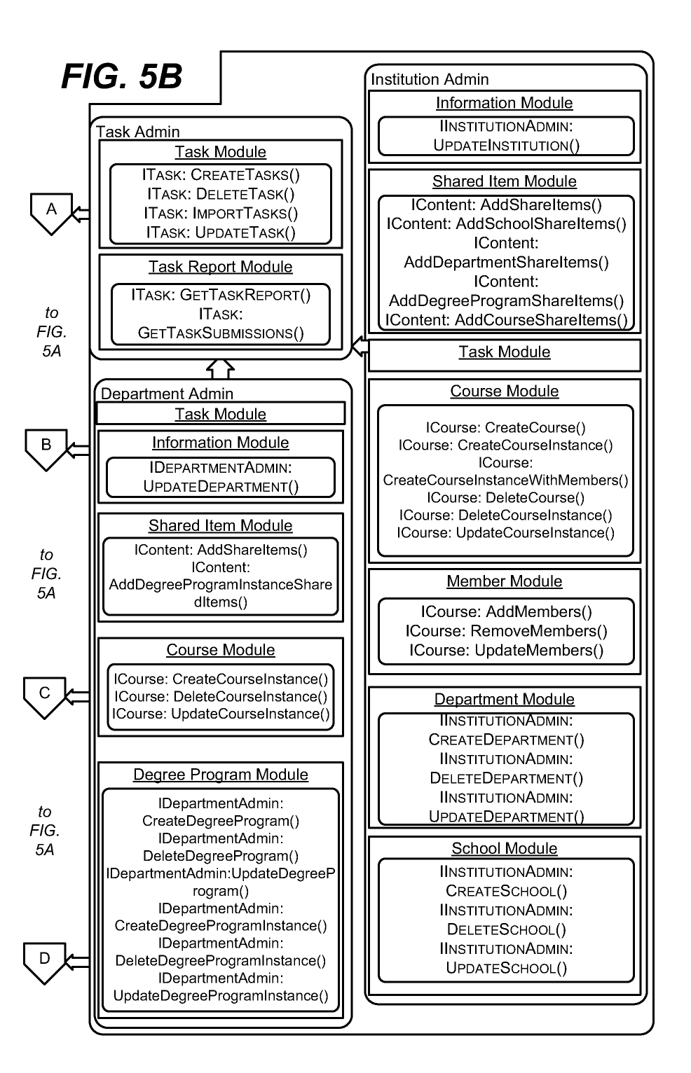

FIGS. 5A and 5B taken together provide example data flow and scenarios regarding a common perspective scenario with respect to example Institution, School, Department and Degree Program services/contracts (FIG. 5A), and from an administrative perspective (FIG. 5B). As can be seen, the interfaces to functions for the administration allow for the creation and administration of tasks, department-related objects, institutional-related objects and so forth.

The above-described services architecture provides the ability for partners/clients to built applications on top of these services. This enables partners/clients to build education applications without the need to consider object relationships, data formats and/or how the data is persisted. The middle tier 110 provides partners/clients with a way to extend existing services from processing and provider perspective. It also supports adding various providers (e.g., providers for content storage, membership and the like).

### EXAMPLE INTERFACES

### EXEMPLARY OPERATING ENVIRONMENT

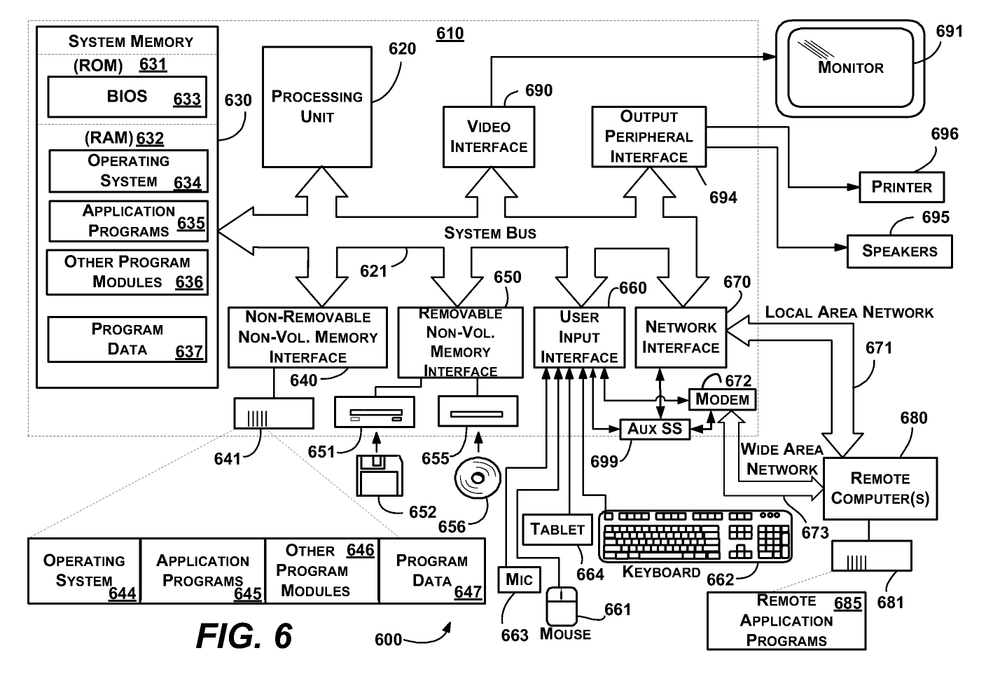

FIG. 6 illustrates an example of a suitable computing and networking environment 600 on which the examples of FIGS. 1-5B may be implemented. The computing system environment 600 is only one example of a suitable computing environment and is not intended to suggest any limitation as to the scope of use or functionality of the invention. Neither should the computing environment 600 be interpreted as having any dependency or requirement relating to any one or combination of components illustrated in the exemplary operating environment 600.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 6, an exemplary system for implementing various aspects of the invention may include a general purpose computing device in the form of a computer 610. Components of the computer 610 may include, but are not limited to, a processing unit 620, a system memory 630, and a system bus 621 that couples various system components including the system memory to the processing unit 620. The system bus 621 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 610 typically includes a variety of computer-readable media. Computer-readable media can be any available media that can be accessed by the computer 610 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 610. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 630 includes computer storage media in the form of volatile and/or nonvolatile memory such as read only memory (ROM) 631 and random access memory (RAM) 632. A basic input/output system 633 (BIOS), containing the basic routines that help to transfer information between elements within computer 610, such as during start-up, is typically stored in ROM 631. RAM 632 typically contains data and/or program modules that are immediately accessible to and/or presently being operated on by processing unit 620. By way of example, and not limitation, FIG. 6 illustrates operating system 634, application programs 635, other program modules 636 and program data 637.

The computer 610 may also include other removable/non-removable, volatile/nonvolatile computer storage media. By way of example only, FIG. 6 illustrates a hard disk drive 641 that reads from or writes to non-removable, nonvolatile magnetic media, a magnetic disk drive 651 that reads from or writes to a removable, nonvolatile magnetic disk 652, and an optical disk drive 655 that reads from or writes to a removable, nonvolatile optical disk 656 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 641 is typically connected to the system bus 621 through a non-removable memory interface such as interface 640, and magnetic disk drive 651 and optical disk drive 655 are typically connected to the system bus 621 by a removable memory interface, such as interface 650.

The drives and their associated computer storage media, described above and illustrated in FIG. 6, provide storage of computer-readable instructions, data structures, program modules and other data for the computer 610. In FIG. 6, for example, hard disk drive 641 is illustrated as storing operating system 644, application programs 645, other program modules 646 and program data 647. Note that these components can either be the same as or different from operating system 634, application programs 635, other program modules 636, and program data 637. Operating system 644, application programs 645, other program modules 646, and program data 647 are given different numbers herein to illustrate that, at a minimum, they are different copies. A user may enter commands and information into the computer 610 through input devices such as a tablet, or electronic digitizer, 664, a microphone 663, a keyboard 662 and pointing device 661, commonly referred to as mouse, trackball or touch pad. Other input devices not shown in FIG. 6 may include a joystick, game pad, satellite dish, scanner, or the like. These and other input devices are often connected to the processing unit 620 through a user input interface 660 that is coupled to the system bus, but may be connected by other interface and bus structures, such as a parallel port, game port or a universal serial bus (USB). A monitor 691 or other type of display device is also connected to the system bus 621 via an interface, such as a video interface 690. The monitor 691 may also be integrated with a touch-screen panel or the like. Note that the monitor and/or touch screen panel can be physically coupled to a housing in which the computing device 610 is incorporated, such as in a tablet-type personal computer. In addition, computers such as the computing device 610 may also include other peripheral output devices such as speakers 695 and printer 696, which may be connected through an output peripheral interface 694 or the like.

The computer 610 may operate in a networked environment using logical connections to one or more remote computers, such as a remote computer 680. The remote computer 680 may be a personal computer, a server, a router, a network PC, a peer device or other common network node, and typically includes many or all of the elements described above relative to the computer 610, although only a memory storage device 681 has been illustrated in FIG. 6. The logical connections depicted in FIG. 6 include one or more local area networks (LAN) 671 and one or more wide area networks (WAN) 673, but may also include other networks. Such networking environments are commonplace in offices, enterprise-wide computer networks, intranets and the Internet.

When used in a LAN networking environment, the computer 610 is connected to the LAN 671 through a network interface or adapter 670. When used in a WAN networking environment, the computer 610 typically includes a modem 672 or other means for establishing communications over the WAN 673, such as the Internet. The modem 672, which may be internal or external, may be connected to the system bus 621 via the user input interface 660 or other appropriate mechanism. A wireless networking component 674 such as comprising an interface and antenna may be coupled through a suitable device such as an access point or peer computer to a WAN or LAN. In a networked environment, program modules depicted relative to the computer 610, or portions thereof, may be stored in the remote memory storage device. By way of example, and not limitation, FIG. 6 illustrates remote application programs 685 as residing on memory device 681. It may be appreciated that the network connections shown are exemplary and other means of establishing a communications link between the computers may be used.

An auxiliary subsystem 699 (e.g., for auxiliary display of content) may be connected via the user interface 660 to allow data such as program content, system status and event notifications to be provided to the user, even if the main portions of the computer system are in a low power state. The auxiliary subsystem 699 may be connected to the modem 672 and/or network interface 670 to allow communication between these systems while the main processing unit 620 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents failing within the spirit and scope of the invention.

What is claimed is:

1. In a computing environment, a system comprising, an interface set to an educational service, including an interface for calling course-related functions of the educational service, including a function to create at least one course instance, the course instance associated with a first user set of at least one user having a first role, and a second user set of at least one user having a second role, in which the roles determine to which course-related function or functions each user has access.

2. The system of claim 1 wherein the interface set corresponds to a web service or a SharePoint® shared service, or both a web service and a SharePoint® shared service.

3. The system of claim 1 wherein the first user set corresponds to student users, wherein the second user set corresponds to a teacher, and further comprising at least one task-related function by which the teacher provides tasks for the students and associates the tasks with the course instance.

4. The system of claim 1 wherein the course instance is associated with data that is accessed through a process engine that executes code of the course-related functions.

5. The system of claim 1 further comprising an interface for calling profile-related functions to maintain data associated with users.

6. The system of claim 1 further comprising an interface for calling membership-related functions to maintain data associated with membership of users of the educational service, including data that determines the roles or roles associated with each user.

7. The system of claim 1 further comprising an interface for calling task-related functions to maintain data associated with tasks, including to associate a task with a course, a group, an institution, a plan, a user profile, a department or a degree program, or any combination of a course, a group, an institution, a plan, a user profile, a department or a degree program.

8. The system of claim 1 further comprising an interface for calling plan-related functions to maintain plan-related data that is associated with a course or a user profile, or any combination of a course or a user profile.

9. The system of claim 1 further comprising an interface for calling scoring-related functions for managing scoring data that is associated with a task instance submission, task instance and course instance

10. The system of claim 1 further comprising an interface for calling group-related functions associated with groups of users, including functions to create groups, delete groups and retrieve group properties.

11. The system of claim 1 further comprising an interface for calling content-related functions to maintain data associated with educational-related content, including content associated with a task, a course, a group, an institution, a plan, a profile, a department or a degree program, or any combination of a task, a course, a group, an institution, a plan, a profile, a department or a degree program.

12. The system of claim 1 further comprising an interface for calling contextual communication-related functions to maintain data associated with contextual communications associated with a course or assignment, or both a course and an assignment, or an interface for calling notification-related functions to create and manage notifications sent to users of the educational service, or both an interface for calling contextual communication-related functions and an interface for calling notification-related functions.

13. The system of claim 1 further comprising an interface for calling institution-related functions to maintain data associated with an institution, including data related to departments, courses or degree programs, or any combination of departments, courses or degree programs.

14. The system of claim 1 further comprising an interface for calling department-related functions to maintain data associated with departments, including data related to courses, department members, or degree programs, or any combination of courses, department members or degree programs.

15. The system of claim 1 further comprising an interface for calling standards-related functions to access data maintained in accordance with a standard, or an interface for calling degree program-related functions to create degree program instances for students that maintain course-related information or department-related information, or both course-related information and department-related information, or both an interface for calling standards-related functions and an interface for calling degree program-related functions.

16. In a computing environment, a method comprising:
providing selected interfaces to functions to users of an educational service, in which the selected interfaces are determined according to a role associated with each user;
receiving a first function call at an interface to an educational service, the first function call requesting association of a task with a course instance;
associating the task with the course in response to the first function call;
receiving a second function call at an interface to an educational service, the second function call requesting information related to the task; and
returning the information related to the task in response to the second function call.

17. In a computing environment, a system comprising, an interface set to an educational service, including an interface for calling course-related functions of the educational service, an interface for calling profile-related functions of the educational service, an interface for calling membership-related functions of the educational service, and an interface for calling task-related functions of the educational service.

18. The system of claim 17 wherein the interface for calling the course-related functions comprises an interface to a course service, wherein the interface for calling the profile-related functions comprises an interface to a profile service, wherein the interface for calling the membership-related functions comprises an interface to a membership service, and wherein the interface for calling the task-related functions comprises an interface to a task service.

19. The system of claim 17 wherein the interface set further comprises an interface for calling plan-related functions of the educational service, an interface for calling group-related functions of the educational service, an interface for calling content-related functions of the educational service, or an interface for calling notification-related functions of the educational service, or any combination of an interface for calling group-related functions of the educational service, an interface for calling content-related functions of the educational service, or an interface for calling notification-related functions of the educational service.

20. The system of claim 17 wherein the interface set further comprises an interface for calling provisioning-related functions of the educational service, an interface for calling institution-related functions of the educational service, an interface for calling department-related functions of the educational service, an interface for calling utilities-related functions of the educational service, an interface for calling standards-related functions of the educational service, an interface for calling degree program-related functions of the educational service, or an interface for calling contextual communication-related functions of the educational service, or any combination of an interface for calling provisioning-related functions of the educational service, an interface for calling institution-related functions of the educational service, an interface for calling department-related functions of the educational service, an interface for calling utilities-related functions of the educational service, an interface for calling standards-related functions of the educational service, an interface for calling degree program-related functions of the educational service, or an interface for calling contextual communication-related functions of the educational service.
